(19) United States
(12) Patent Application Publication
(10) Pub. No.: US 2009/0176611 A1
(43) Pub. Date: Jul. 9, 2009

(54) Auxiliary Unit Drive for a motor vehicle

(76) Inventor: Gary Avery, Ludwigsburg (DE)

Correspondence Address: KLAUS J. BACH, 4407 TWIN OAKS DRIVE, MURRYSVILLE, PA, 15668, US

(21) Appl. No.: 12/322,952

(22) Filed: Feb. 9, 2009

Related U.S. Application Data
(63) Continuation-in-part of application No. PCT/EP2007/006927, filed on Aug. 6, 2007.

(30) Foreign Application Priority Data
Aug. 11, 2006 (DE) 10 2006 037 576.9

(51) Int. Cl. F16H 57/08

(52) U.S. Cl. 475/5

(57) ABSTRACT

In an auxiliary unit drive for a motor vehicle, having planetary gearing (P), with a sun gear (S) of the planetary gearing (P) connected in a power-transmitting fashion to a first electric machine (EM1), a planet gear carrier (PT) connected in a power-transmitting fashion to an internal combustion engine (VM), and a first ring gear (H1) connected to at least one auxiliary unit (AG), the auxiliary unit drive has two planet gear sets (PR1, PR2) which are rotatably supported by the planet gear carrier (PT), a second ring gear (H2) which can be held still by a first brake (BS), with the first planet gear set (PR1) meshing with the first ring gear (H1) and the sun gear (S), and the second planet gear set (PR2) meshing with the second ring gear (H2) and the first planet gear set (PR1), a first clutch (KVE), by means of which the internal combustion engine (VM) can be coupled to the first electric machine (EM1), and a first overrunning clutch (FVG), by means of which the planet gear carrier (PT) can rotate in only one rotational direction, whereby a high level of efficiency during starting or at low speeds of the internal combustion engine and also during operation of the vehicle by means of the first electric machine (EM1) is achieved.

This is a Continuation-In-Part Application of pending international application PCT/EP2007/06927 filed Aug. 6, 2007 and claiming the priority of German patent application 10 2006 037 576.9 filed Aug. 11, 2006.

### BACKGROUND OF THE INVENTION

The invention relates to an auxiliary unit drive for a motor vehicle with a planetary gearing including a sun gear connected to a first electric motor, a planetary gear carrier connected to an internal combustion engine and a ring gear connected to auxiliary equipment.

Auxiliary equipment units, such as for example air-conditioning compressors, fans, power-steering pumps or oil and water pumps which are used in motor vehicles, are driven with a rotational speed proportional to the rotational speed of the internal combustion engine. However, said auxiliary units must meet the demands which are placed on them over a wide rotational speed range, for example from 600 to 6000 rpm in the case of spark-ignition engines, that is to say with a factor of 10 from the highest rotational speed to the lowest rotational speed. As a result, a water pump, for example, which must deliver a sufficient coolant flow at idle of the internal combustion engine, delivers an unnecessarily high coolant quantity at relatively high internal combustion engine rotational speeds, and thereby generates considerable losses. Other auxiliary units in turn provide marginal performance at idle and are seldom operated in the optimum operating range.

In order to be able to adequately drive auxiliary units when of the internal combustion engine is idling, a separate electric motor may be provided which drives the auxiliary drive output of the internal combustion engine via an overrunning clutch.

An overrunning clutch is a device which decouples a part of a drivetrain from the rotational movement if the load conditions change. An overrunning clutch may for example be designed as a roller-type overrunning clutch, a plate-type overrunning clutch or a clamping-body-type overrunning clutch. A clamping-body-type overrunning clutch is composed of an inner ring, an outer ring and clamping bodies which are mounted in a cage. In the event of drive being imparted by the inner ring, springs press the clamping bodies slightly between the inner ring and the outer ring such that the clamping bodies, depending on their rotation, move into their receiving spaces. Because the receiving spaces of the clamping bodies taper in the direction away from the springs, the transmitted torque becomes greater the further the inner ring is rotated with respect to the outer ring. With a suitable selection of the angle of incidence of the clamping wedge which is formed, the design is—on account of the physical design—absolutely slip-free even with the best lubrication, and a self-locking state prevails. The tapering angle must for this purpose be selected such that said tapering angle is less than or equal to the inverse tangent of the coefficient of sliding friction μ. If the rotational direction is reversed or if the outer rotational speed is greater than the inner rotational speed, the clamping bodies roll in the direction of the spring, and the clamping action is eliminated.

Electric machines which are operated both as a motor and also as a generator likewise have the problem that they require a different transmission ratio in the motor operating mode than they require in the generator mode. This usually leads to over-dimensioning of the electric machines. For example, starter-generators require a higher transmission ratio in the starter mode than they require in the generator mode, which leads to an over-dimensioned design for starter operation.

Electrical auxiliary units are also known which are used in particular in hybrid vehicles, since sufficient electrical energy is available here to supply the auxiliary units. Said electrical auxiliary units are however expensive.

DE 43 33 907 C2 discloses an auxiliary unit drive for a motor vehicle, having a superposition gearing with an input base and two output bases, with the input base being rotationally connected to an internal combustion engine, the first output base being rotationally connected to an auxiliary unit combination and the second output base being rotationally connected to an induction machine which is operated as a generator. The rotational speed of the auxiliary unit combination can be controlled in a continuously variable manner by means of the superposition gearing, in such a way that said auxiliary unit combination is operated in a uniform range which is as ideal as possible. However, in continuously variable operation, the generator power of the induction machine can be controlled only to a restricted extent on account of the dependency on the torque demand of the auxiliary unit combination. To switch from operation with continuously variable transmission to operation with direct transmission, it is disadvantageously necessary for a plurality of clutches to be switched.

It is the principal object of the present invention to provide an auxiliary unit drive for a motor vehicle, which auxiliary unit drive has a high level of efficiency both during starting of the internal combustion engine and also when the vehicle is being driven by means of an electric machine.

### SUMMARY OF THE INVENTION

In an auxiliary unit drive for a motor vehicle, having planetary gearing (P), with a sun gear (S) of the planetary gearing (P) connected in a power-transmitting fashion to a first electric machine (EM1), a planet gear carrier (PT) connected in a power-transmitting fashion to an internal combustion engine (VM), and a first ring gear (H1) connected to at least one auxiliary unit (AG), the auxiliary unit drive has two planet gear sets (PR1, PR2) which are rotatably supported by the planet gear carrier (PT), a second ring gear (H2) which can be held still by a first brake (BS), with the first planet gear set (PR1) meshing with the first ring gear (H1) and the sun gear (S), and the second planet gear set (PR2) meshing with the second ring gear (H2) and the first planet gear set (PR1), a first clutch (KVE), by means of which the internal combustion engine (VM) can be coupled to the first electric machine (EM1), and a first overrunning clutch (FVG), by means of which the planet gear carrier (PT) can rotate in only one rotational direction, whereby a high level of efficiency during starting or at low speeds of the internal combustion engine and also during operation of the vehicle by means of the first electric machine (EM1) is achieved.

With the use of a first clutch, by means of which the internal combustion engine can be coupled to the first electric machine, the first electric machine can drive the internal combustion engine directly, as a result of which the operational efficiency is increased and the planetary gearing is protected, in particular during a warm start of the internal combustion engine. Likewise, in this way, when the first clutch is closed, the generator power of the first electric machine is not dependent on the torque demand of the auxiliary equipment. This leads to the advantage that the first electric machine can be controlled so as to operate as a generator or as a motor independently of the auxiliary unit. Also boost operation by means of an additional drive torque of the first electric machine is possible. Furthermore, the switching of the first clutch permits a simple switchover between continuously variable operation and direct operation.

If the auxiliary unit drive has a first overrunning clutch, by means of which the planet gear carrier of the planetary gearing can rotate in only one direction, it is possible, even when the internal combustion engine is at a standstill, to drive the first ring gear which is connected in a power-transmitting fashion to at least one auxiliary unit. This is particularly advantageous in vehicles which can be driven purely electrically, since it is necessary here for example for the power-steering pump of the power steering system to be driven. Here, the auxiliary units, such as for example the air-conditioning system and power-steering system, are operated in such a way that, for example during a period of increased power-steering pump power requirements, the power consumption of the air-conditioning compressor is reduced. In this way, it is possible to limit the total power required for auxiliary units.

If the auxiliary unit drive has an expanded planetary gearing with two planet gear sets and two ring gears, in which only the first planet gear set meshes with the sun gear of the planetary gearing and with the first ring gear, and the second planet gear set meshes with the first planet gear set and with the second ring gear, it is advantageously possible for a first brake, by means of which the second ring gear can be fixedly held with respect to a housing part, to serve as a start clutch. In this case, when the auxiliary unit drive is running, the internal combustion engine can be started with a particular starting transmission ratio by the first electric machine. Such an internal combustion engine start is characterized by low vibrations.

The planetary gearing advantageously permits
a higher torque during starting of the internal combustion engine by means of the first electric machine when the first clutch is open, in particular during a cold start,
a torque distribution between the internal combustion engine and the first electric machine during driving of the at least one auxiliary unit, in particular when the internal combustion engine is at idle, and
continuously variable control of the auxiliary unit drive, as a result of which the operating range of the at least one auxiliary unit can be reduced with regard to its rotational speed spectrum.

By means of the auxiliary unit according to the invention, it is advantageously possible to realize the following operating functions of a hybrid drivetrain:
generator function by means of generator operation of the first electric machine (an alternator of a vehicle with conventional drive is no longer required),
start/stop function by starting the internal combustion engine by means of the electric machine,
boost function by means of additional drive torque of the first electric machine, and
drive of the at least one auxiliary unit by means of the first electric machine when the internal combustion engine is at a standstill.

The second overrunning clutch, by means of which the first ring gear of the planetary gearing, which is connected in a power-transmitting fashion to at least one auxiliary unit, can rotate in only one rotational direction, advantageously permits a transmission ratio, and therefore a torque multiplication, during starting of the internal combustion engine by means of the first electric machine, in particular during a cold start. In this way, a start of the internal combustion engine is advantageously possible in which the internal combustion engine is accelerated to its idle rotational speed before the injection process begins. This leads to reduced exhaust-gas emissions in relation to a conventional start of an internal combustion engine, and to an improved starting process with regard to comfort, which is highly advantageous in particular during start/stop operation.

If the first clutch, by means of which the internal combustion engine can be coupled to the first electric machine, is a centrifugal clutch, considerable cost advantages can be achieved. In this case, however, the possibilities of driving the at least one auxiliary unit in a continuously variable fashion according to demand in all operating ranges and of limiting the maximum rotational speed are lost.

If the auxiliary unit has a second brake, by means of which the first element of the planetary gearing can be fixedly held with respect to a housing part, it is possible for the rotational speed of the at least one auxiliary unit to be increased. This is particularly advantageous at low internal combustion engine rotational speeds, in particular when a vehicle drivetrain has a further electric machine for generating electrical energy.

The invention will become more readily apparent from the following description thereof on the basis of the accompanying drawings. Exemplary embodiments of the invention are illustrated in the drawings in simplified form and are explained in more detail in the following description:

### BRIEF DESCRIPTION OF THE DRAWINGS

FIG. 1 is a schematic illustration of an auxiliary unit drive according to the invention, having an expanded planetary gearing, a first clutch for coupling a first electric machine and an internal combustion engine, and a first overrunning clutch for permitting the planet gear carrier to rotate only in one rotational direction;

FIG. 2 is an illustration of the rotational speeds of the at least one auxiliary unit, of the internal combustion engine and of the first electric machine during starting of the internal combustion engine in an auxiliary unit drive according to FIG. 1;

FIG. 3 is an illustration of the rotational speeds of the at least one auxiliary unit, of the internal combustion engine and of the first electric machine in the further operation of the auxiliary unit drive according to FIG. 1;

FIG. 4 is a schematic illustration of the auxiliary unit drive according to FIG. 1, with a second overrunning clutch for determining the rotational direction of the first ring gear;

FIG. 5 is an illustration of the rotational speeds of the at least one auxiliary unit, of the internal combustion engine and of the first electric machine during starting of the internal combustion engine in an auxiliary unit drive according to FIG. 4,

FIG. 6 is a schematic illustration of the auxiliary unit drive according to FIG. 1, with an additional second brake for holding the sun gear so as to be fixed;

FIG. 7 is an illustration of the rotational speeds of the at least one auxiliary unit, of the internal combustion engine and of the first electric machine in an auxiliary unit drive according to FIG. 6;

FIG. 8 is a schematic illustration of the auxiliary unit drive according to FIG. 1, with it being possible for the planet gear carrier to be connected by means of a second clutch to an input shaft of a drive transmission, which is also connected in a power-transmitting fashion to a second electric machine; and

FIG. 9 is a schematic illustration of the auxiliary unit drive according to FIG. 4, with it being possible for the planet gear carrier to be connected by means of a second clutch to a third ring gear of a drivetrain planetary gearing.

### DESCRIPTION OF PARTICULAR EMBODIMENTS

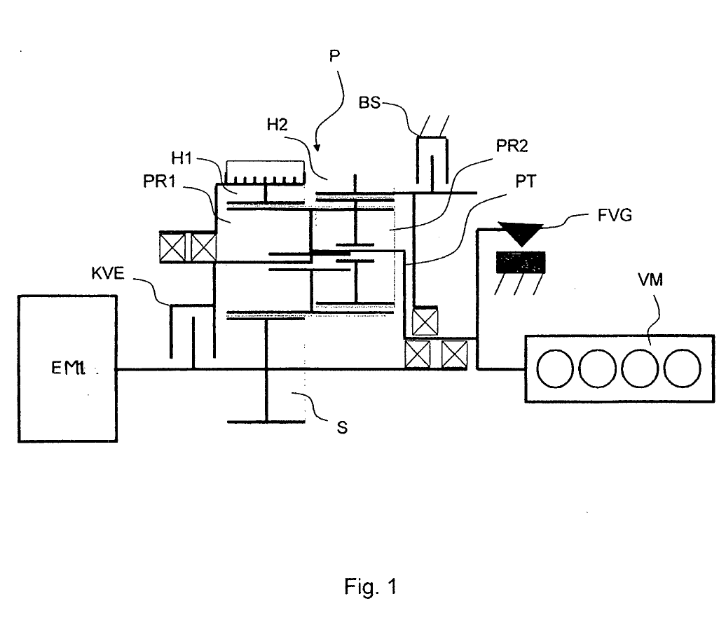

FIG. 1 shows an auxiliary unit drive according to the invention with an expanded planetary gearing P including a sun gear S, two planet gear sets PR1, PR2 and two ring gears H1, H2, wherein the second ring gear H2 can be fixedly held with respect to a housing part by means of a first brake BS.

The planets of the two planet gear sets PR1, PR2 are mounted with their axles in each case in a planet gear carrier PT. The planets of the first planet gear set PR1 mesh with the sun gear S and with the first ring gear H1 and with the planets of the second planet gear set PR2. The planets of the second planet gear set PR2 also mesh with the second ring gear H2.

Here, a first electric machine EM1 is connected in a power-transmitting fashion to the sun gear S, an internal combustion engine VM is connected in a power-transmitting fashion to the planet gear carrier PT, and at least one auxiliary unit AG is connected in a power-transmitting fashion to the first ring gear H1. The internal combustion engine VM can be coupled to the first electric machine EM1 by means of a first clutch KVE which is, for example a plate-type clutch.

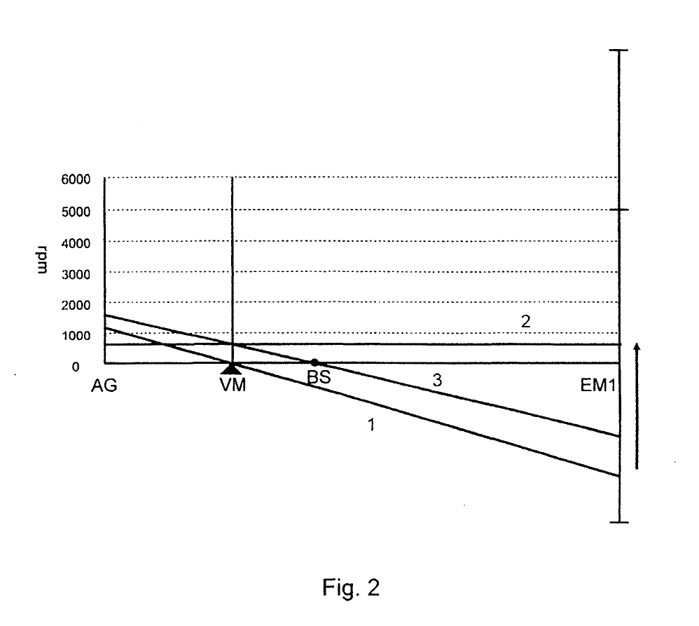

Furthermore, the auxiliary unit drive has a first overrunning clutch FVG, by means of which the planet gear carrier PT can rotate only in only one rotational direction with respect to a housing part. It is thereby possible, even when the internal combustion engine VM is at a standstill, for the drive of the at least one auxiliary unit AG to be driven by means of the first electric machine EM1. Here, the first overrunning clutch FVG—as illustrated by the straight line 1 of FIG. 2—supports the torque of the drive of the at least one auxiliary unit AG.

This is particularly advantageous in vehicles which can be driven purely electrically, that is to say so-called fully hybrid vehicles, since it is necessary here for example for the power-steering pump of the power-steering system to be driven while the vehicle is traveling purely under electrical power. Here, the auxiliary units, such as for example the air-conditioning system and power-steering system, are operated in such a way that, for example during a period of increased power-steering pump power, the power of the air-conditioning compressor is reduced. In this way, it is possible to limit the total power required for auxiliary units.

The first overrunning clutch FVG may also be arranged at some other point along the drive output shaft of the internal combustion engine VM (crankshaft) if this is expedient, for example with regard to the available installation space.

Further advantages of the support of the planet gear carrier PT by means of the first overrunning clutch FVG are also provided in a vehicle which is driven purely electrically.

FIG. 2 shows the rotational speed conditions of the at least one auxiliary unit AG, of the internal combustion engine VM and of the first electric machine EM1. The rotational speeds are plotted in revolutions per minute on the vertical axis. The intervals on the horizontal axis between the at least one auxiliary unit AG, the internal combustion engine VM and the first electric machine EM1 result from the transmission ratios of the planetary gearing P, in such a way that the rotational speeds relating to a certain operating point can be connected by a straight line. Two known rotational speeds therefore yield the rotational speed of the third element.

If the internal combustion engine VM is to be started proceeding from an operating state as shown by straight line 1 in FIG. 2, that is to say in which the drive of the at least one auxiliary unit AG is driven by the first electric machine EM1 with the first clutch KVE open, then this is advantageously possible, with the drive of the at least one auxiliary unit AG running by closing the first clutch KVE. This operation is illustrated in FIG. 2 by an arrow from the straight line 1 to the straight line 2.

Here, however, there would be no transmission ratio during starting of the internal combustion engine VM. Furthermore, the closing of the first clutch KVE can lead to restrictions with regard to driving comfort, wherein the operational reliability also has to be taken into consideration as a result of the high loading.

As an alternative, in order to start the internal combustion engine VM without it being necessary for the drive of the at least one auxiliary unit AG to be stopped, the first brake BS, which fixedly holds the second ring gear H2, can particularly preferably be used as a start clutch. Proceeding from the state according to straight line 1, the first brake BS is thus closed, as a result of which the rotational speed line 3 passes through the point BS. The second ring gear H2 is thus at a standstill. This results in a starting transmission ratio, in contrast to a direct coupling of the internal combustion engine VM to the first electric machine EM1 by means of the first clutch KVE. Said internal combustion engine start is additionally characterized by low vibrations.

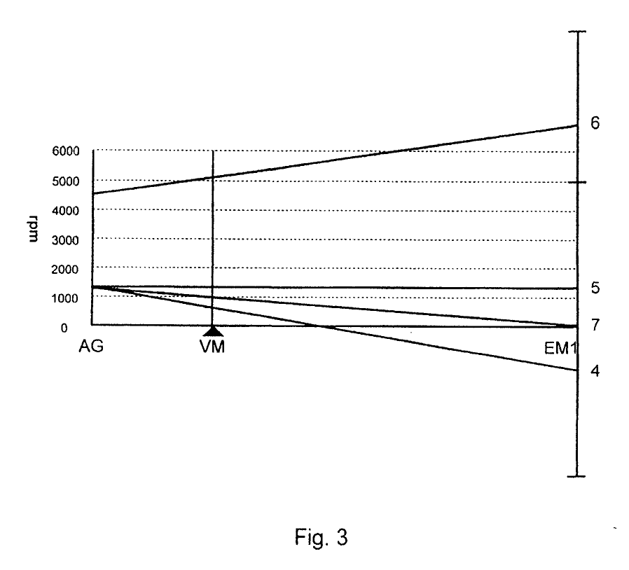

Straight line 4 in FIG. 3 shows a state in which the drive of the at least one auxiliary unit AG is assisted according to demand, for example only in the event of an increased power requirement of the power-steering pump or of the air-conditioning compressor, by means of the first electric machine EM1, and the internal combustion engine VM is at idle (approx. 600 rpm). Depending on the configuration and operating state, the first electric machine EM1 must contribute only 20-40% to the demanded power in said boost mode. Here, the first clutch KVE is open.

If the rotational speed of the internal combustion engine VM falls below the idle rotational speed, for example when the vehicle comes to a standstill, then the first electric machine EM1 should switch from generator operation to motor operation.

According to the exemplary embodiment in FIG. 1, for a rotational speed at the lower limit of normal operation of the internal combustion engine VM of 900 rpm and a stationary first electric machine EM1, the resulting rotational speed for driving the at least one auxiliary unit AG is 1200 rpm (straight line 7 in FIG. 3).

Above the rotational speed, as illustrated by the straight line 5, the first clutch KVE is closed in order to thereby permit independent generator or power boost operation of the electric motor EM1.

Below said rotational speed, in the event of a power demand of the at least one auxiliary unit AG, the first clutch KVE is opened, and the rotational speed of the drive of the at least one auxiliary unit AG is controlled by means of the first electric machine EM1, in such a way that said rotational speed does not fall below 1200 rpm. The rotational speed range for the auxiliary units is therefore restricted in the downward direction.

By a continuously variable control of the drive of the at least one auxiliary unit AG, it is likewise possible to limit the maximum rotational speed of the drive of the at least one auxiliary unit AG to a rotational speed of 4500 rpm, as shown for example by straight line 6. Here, the first electric machine EM1 is operated as a generator, with the power of the latter being dependent on the torque demand of the drive of the at least one auxiliary unit AG. The restricted controllability can be compensated for by means of a further electric machine in the drivetrain of the motor vehicle.

Furthermore, in this way the rotational speed of the drive of the at least one auxiliary unit AG can be controlled according to demand.

As a result of the fact that the drive of the at least one auxiliary unit AG can be driven not only by means of the internal combustion engine VM but rather also by means of the first electric machine EM1, the internal combustion engine VM need no longer be designed such that it can ensure the functions of all the auxiliary units even when it is at idle.

The first electric machine EM1, the internal combustion engine VM and the sun gear S of the planetary gearing P are arranged coaxially in FIG. 1. It is however likewise possible for the first electric machine EM1 to be arranged outside said axis and to be connected to the sun gear S of the planetary gearing P by means of a belt drive, chain drive or gearwheel drive. Here, further optimization possibilities are provided by a selection of the transmission ratio of the first electric machine EM1.

The first clutch KVE by means of which the internal combustion engine VM can be coupled to the first electric machine EM1, is preferably of positively locking design. A design of the first clutch KVE as a centrifugal clutch leads to considerable cost advantages. In this case however, the possibilities of driving the at least one auxiliary unit AG in a continuously variable fashion according to demand in all operating ranges, and of limiting the maximum rotational speed of the auxiliary unit AG are lost.

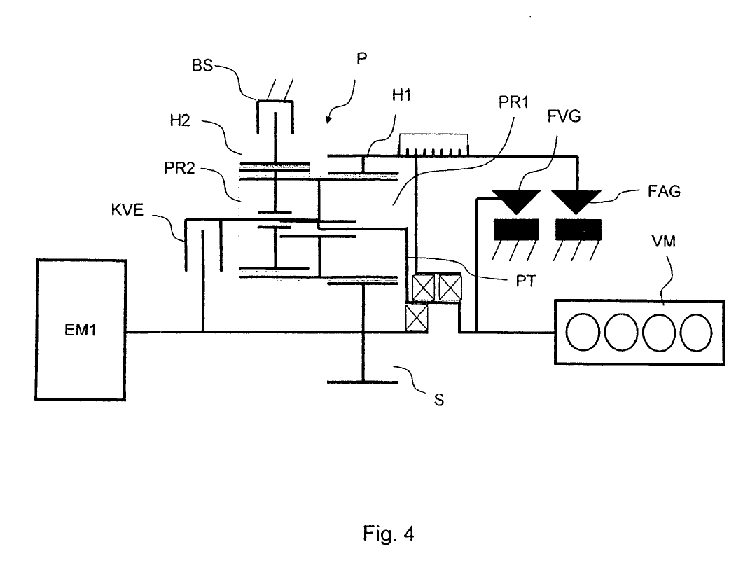

FIG. 4 shows an auxiliary unit drive according to the invention with the elements of the auxiliary unit drive according to FIG. 1 and a second overrunning clutch FAG, whose one end is connected to the first ring gear H1 and whose other end is connected to a housing part. By means of the second overrunning clutch FAG, the first ring gear H1 can rotate only in one direction, specifically the drive direction of the internal combustion engine VM.

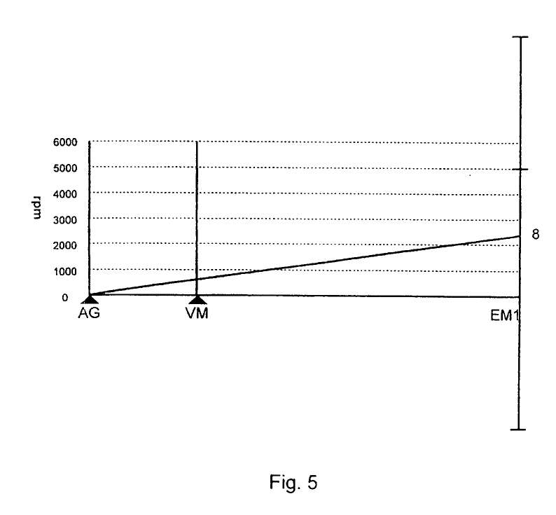

As shown by the straight line 8 in FIG. 5, with this arrangement, in an alternative method for starting the internal combustion engine VM by the first electric machine EM1 with the first clutch KVE open, a lever action is obtained, that is to say the torque at the planet gear carrier PT approximately tripled. With this transmission ratio, the first electric machine EM1, which can generate a mechanical power of only 3-6 kW for driving the at least one auxiliary unit AG, can start the internal combustion engine VM without difficulty.

During the starting process, which is particularly preferably applied during a cold start, the internal combustion engine VM is firstly brought up to the normal idle rotational speed before the injection of fuel is commenced. This leads to lower exhaust-gas emissions and to improved comfort in relation to a conventional starting process using a starter. In this way, the internal combustion engine VM can, taking into consideration exhaust-gas limit values, be operated more frequently in start/stop operation without exceeding exhaust gas emission limits.

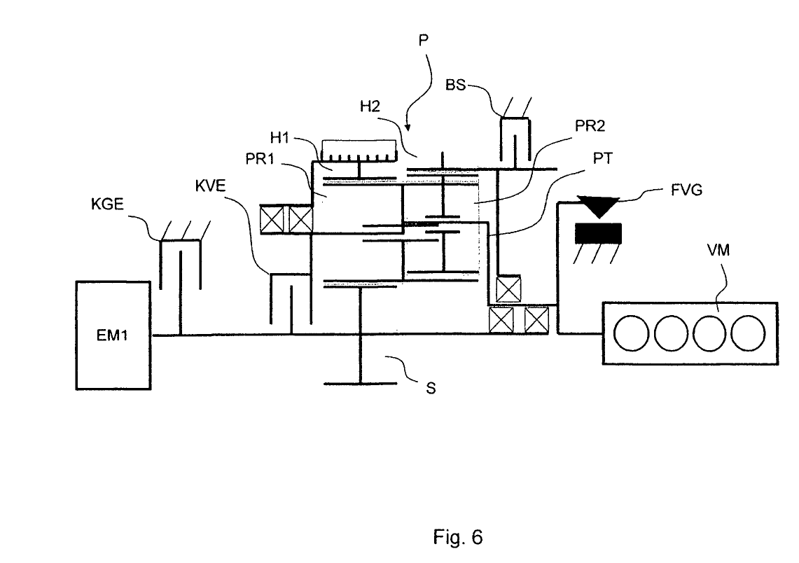

FIG. 6 shows an auxiliary unit drive according to the invention, which has the elements of the auxiliary unit drive according to FIG. 1 and additionally a second brake KGE by means of which the sun gear S of the planetary gearing P can be fixedly held with respect to a housing part.

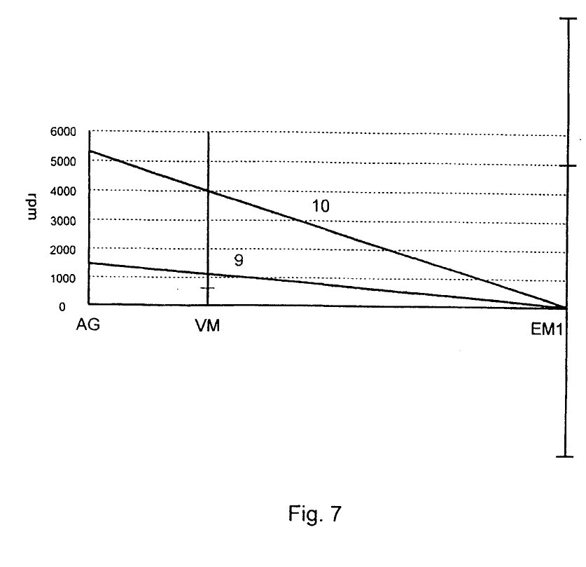

As is clearly shown by the straight lines 9 and 10 in FIG. 7, it is possible, when the sun gear S is fixedly held by the second brake KGE and the first electric machine EM1 is thereby fixedly held, for the rotational speed of the drive of the at least one auxiliary unit AG to be increased in relation to the rotational speed of the internal combustion engine VM. This is advantageous in particular at low rotational speeds of the internal combustion engine VM. The fact that the first electric machine EM1 cannot generate electrical energy in said fixedly braked state can be compensated for example by means of a second electric machine in the drivetrain of the motor vehicle.

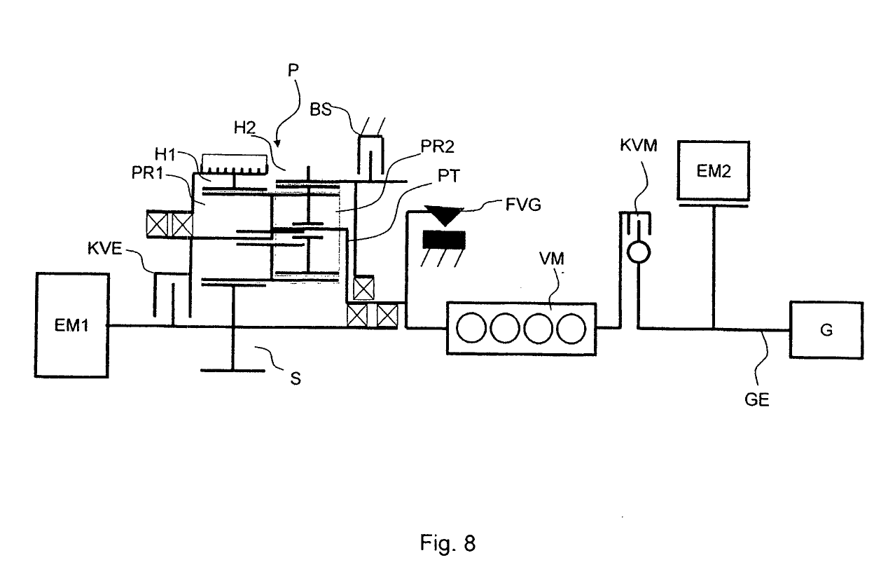

FIG. 8 shows an auxiliary unit drive according to the invention with the elements of the auxiliary unit drive according to FIG. 1, wherein the planet gear carrier PT and also the drive output shaft of the internal combustion engine VM can be connected by means of a second clutch KVM and preferably a torsional vibration damper to a transmission input shaft GE of a drive transmission G.

The drive transmission G is connected at the drive-output side to an axle drive unit and thereby drives wheels of the motor vehicle. As a drive transmission G, preferably a gear change transmission is used. It is however possible for a continuously variable transmission to serve as a drive transmission G.

A second electric machine EM2 is also connected in a power-transmitting fashion to the transmission input shaft GE, which second electric machine EM2 can be operated both as a generator and as a motor. If, for example, the second clutch KVM is open, then the vehicle can be driven by means of the second electric machine EM2 alone. When the second clutch KVM is closed, it is possible for a drive torque to be imparted from the internal combustion engine VM and/or from the first electric machine EM1 and/or from the second electric machine EM2. In this case, it is also possible for one or both electric machines EM1, EM2 to be operated as generators. It is likewise possible, when the second clutch KVM is closed, for the second electric machine EM2 to serve for starting the internal combustion engine VM.

Instead of being combined with the elements of the auxiliary unit drive according to FIG. 1, the elements which are arranged at the drive output side of the second clutch KVM could also be combined with elements of the auxiliary unit drives according to FIG. 4 or 6.

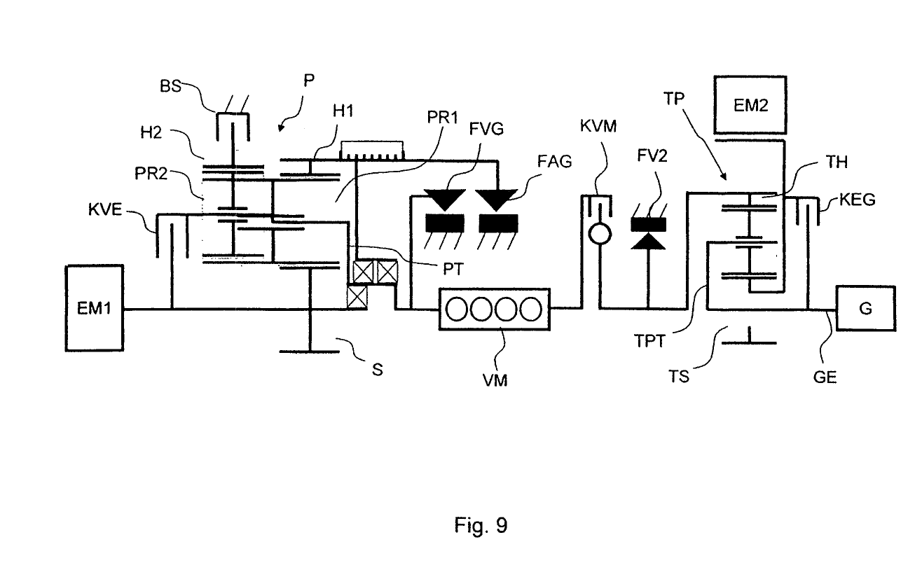

FIG. 9 illustrates an auxiliary unit drive according to the invention with the elements of the auxiliary unit drive according to FIG. 4, wherein the planet gear carrier PT and therefore the drive output shaft of the internal combustion engine VM can be connected by means of a second clutch KVM to a third ring gear TH of a drivetrain planetary gearing TP. The planet gear carrier PT could also be connected to some other element of the drivetrain planetary gearing TP, but this would result in less advantageous transmission ratio conditions.

By means of a third overrunning clutch FV2, which is connected to the third ring gear TH, a rotation of the third ring gear TH relative to a housing part is possible in only one direction.

A second electric machine EM2 is connected to a sun gear TS of the drivetrain planetary gearing TP. A planet gear carrier of the drivetrain planetary gearing TP is connected to the transmission input shaft GE of the drive transmission G.

Furthermore, the planet gear carrier TPT and therefore the transmission input shaft GE can be coupled by means of a third clutch KEG directly to the sun gear TS and therefore to the second electric machine EM2.

It is therefore possible, when the third clutch KEG is open and the second clutch KVM is open, for the motor vehicle to be driven purely electrically by means of the second electric machine EM2 with a certain transmission ratio via the drive train planetary gearing TP. In this case, the at least one auxiliary unit AG can be driven by means of the first electric machine EM1 or the internal combustion engine VM.

It is likewise possible, with the third clutch KEG open and the second clutch KVM closed, for the motor vehicle to be driven with a continuously variable transmission ratio. Here, the rotational speed of the transmission input shaft GE can be controlled by means of the rotational speeds of the second electric machine EM2 and of the internal combustion engine VM. In said mode, a geared neutral function is likewise possible, in which the rotational speeds of the internal combustion engine VM and of the second electric machine EM2 are set in such a way that the rotational speed of the transmission input shaft GE is zero and the motor vehicle is therefore at a standstill.

When the third clutch KEG is closed and the second clutch KVM is open, it is possible for the motor vehicle to be driven purely electrically directly by means of the second electric machine EM2 without a transmission ratio.

When the third clutch KEG is closed and the second clutch KVM is closed, the transmission input shaft GE, the internal combustion engine VM and the second electric machine EM2 have the same rotational speed, with it being possible for the motor vehicle to be driven by means of the internal combustion engine VM and the second electric machine EM2.

In all of the drive modes described above, it is also possible for one or both electric machines EM1, EM2 to be operated as generators.

Instead of being combined with the elements of the auxiliary unit drive according to FIG. 4, the elements arranged at the drive output side of the second clutch KVM could also be combined with elements of the auxiliary unit drives according to FIG. 1 or 6.

What is claimed is:

1. An auxiliary unit drive for a motor vehicle comprising an internal combustion engine (VM) and a first electric machine (EM1) with planetary gearing (P) disposed therebetween, the planetary gearing (P) including
a sun gear (S) connected in a power-transmitting fashion to the first electric machine (EM1),
a planet gear carrier (PT) being connected in a power-transmitting fashion to the internal combustion engine (VM),
a first ring gear (H1) connected in a power-transmitting fashion to at least one auxiliary unit (AG),
two planet gear sets (PR1, PR2) which are rotatably supported by the planet gear carrier (PT),
a second ring gear (H2) connected to a first brake (BS) so that it can be fixedly held with respect to a housing part by means of the first brake (BS),
the first planet gear set (PR1) meshing with the first ring gear (H1) and the sun gear (S), and the second planet gear set (PR2) meshing with the second ring gear (H2) and the first planet gear set (PR1).
a first clutch (KVE), for coupling which the internal combustion engine (VM) to the first electric machine (EM1), and
a first overrunning clutch (FVG), connected to the planet gear carrier (PT) so as to permit its rotation in only one direction.

2. The auxiliary unit drive as claimed in claim 1, wherein a second overrunning clutch (FAG), is connected to the first ring gear (H1) so that the first ring gear (H1) of the planetary gearing (P) can rotate in only one rotational direction.

3. The auxiliary unit drive as claimed in claim 1, wherein a second brake (KGE), is connected to the sun gear (S) of the planetary gearing (P) for fixedly holding the sun gear (S) with respect to a housing part.

4. The auxiliary unit drive as claimed in claim 1, wherein a second clutch (KVM) is provided in the engine drive to the planet gear carrier (PT) of the planetary gearing (P) for connecting the internal combustion engine (VM) to a transmission input shaft (GE) of a drive transmission (G), with a second electric machine (EM2) being connected in a power-transmitting fashion to the transmission input shaft (GE).

5. The auxiliary unit drive as claimed in claim 4, wherein a third overrunning clutch (FV2) is provided in the engine drive train between the second clutch (KVM) and a drive train planetary gearing (TP), the planet gear carrier (PT) of the planetary gearing (P) being connectable by means of the second clutch (KVM) to an element (TH) of the drive train planetary gearing (TP), the element (TH) of the drivetrain planetary gearing (TP) being rotatable in only one rotational direction by means of the third overrunning clutch (FV2).

6. The auxiliary unit drive as claimed in claim 1, wherein the first clutch (KVE) is a centrifugal clutch.
